(19) United States
(12) Patent Application Publication
(10) Pub. No.: US 2026/0256645 A1
(43) Pub. Date: Sep. 3, 2026

(54) Percussive massage device

(71) Applicant: ADVANCEMED LTD., Petach Tikva (IL)

(72) Inventors: Itzhak FRIEDMAN, Petach Tikva (IL); Elena REPIN, Petach Tikva (IL)

(21) Appl. No.: 19/163,904

(22) PCT Filed: Mar. 10, 2024
(86) PCT No.: PCT/IB2024/052305

§ 371 Date: Sep. 10, 2025

Related U.S. Application Data
(60) Provisional application No. 63/489,428, filed on Mar. 10, 2023.

(30) Foreign Application Priority Data
Jul. 31, 2024 (IL) 314662

(51) Int. Cl. A61H 23/00; A61H 23/02

(52) U.S. Cl. CPC A61H 23/006; A61H 23/0254; A61H 2201/0153; A61H 2201/1215; A61H 2201/1436; A61H 2201/149; A61H 2201/1664; A61H 2201/501; A61H 2201/5025; A61H 2201/5035; A61H 2201/5038; A61H 2201/5069; A61H 2201/5097

(57) ABSTRACT

A percussive massage device coupled to a treatment head and including a hand-held housing including a handle and a body. A piston disposed within the body is adapted to be coupled to the treatment head. A motor disposed within the body is adapted to rotate about a shaft. A reciprocation assembly disposed between the piston and the motor couples the piston to the motor such that rotation of the motor drives reciprocal motion of the piston, having a stroke length. A length-changing assembly is associated with the reciprocation assembly, and is adapted to modify a position of the reciprocation assembly relative to the shaft of the motor, thereby to modify the stroke length of the piston. A controller is adapted to activate the motor to cause the piston to reciprocate in accordance with a treatment protocol.

### FIELD OF THE INVENTION

The invention, in some embodiments, relates to the field of percussive massage devices, and more specifically to a percussive massage device having a variable length reciprocation mechanism and to methods of use thereof.

### BACKGROUND OF THE INVENTION

Percussive massage devices are used extensively by the general public and sport enthusiasts, as well as by various therapists and medical practitioners to assist or improve in various bodily ailments, including reducing muscle fatigue, recovering after sport, reducing skeletal pain, improving range of motion, preventing muscle tightness, and the like. Various percussive massage devices, including electromechanical percussive massage devices, are available on the market for various types of treatment.

Typically, percussive massage devices include an electric motor driving a reciprocating piston within a cylinder, where a treatment head is coupled to the end of the piston. The percussive effect provided by a percussive device is typically controlled by the specific treatment head used. The depth of impact on the tissue, or the force applied by the device, is a function of the frequency and stroke length of the reciprocation assembly.

In currently available massage devices, the stroke length of the reciprocation assembly is fixed. Consequently, the amount of force applied by the device is within a limited range, and is only controllable by switching the treatment head. As a result, the massage therapist or practitioner must use different percussive devices for different types of treatment, and ends up owning a large number of devices, each suitable for a very specific use. Furthermore, the amount of force delivered in most devices is insufficient for treating some parts of the body. There is therefore a need in the art for a percussive device having an adaptable reciprocation length, enabling the therapist or practitioner to adapt the settings of a single device to carry out a variety of treatments. Such a device could replace multiple devices in the practitioner's clinic.

### SUMMARY OF THE INVENTION

In accordance with an embodiment of the disclosed technology, there is provided a percussive massage device, adapted to be coupled to a treatment head. The percussive massage device includes a hand-held housing including a handle and a body. A piston is disposed within the body, and is adapted to be coupled to the treatment head. A motor is disposed within the body, and is adapted to rotate about a shaft. A reciprocation assembly is disposed between the piston and the motor and couples the piston to the motor such that rotation of the motor drives reciprocal motion of the piston. The reciprocal motion of the piston has a stroke length. A length-changing assembly is functionally associated with the reciprocation assembly, and is adapted to modify a position of the reciprocation assembly relative to the shaft of the motor, thereby to modify the stroke length of the piston. A controller is adapted to activate the motor to cause the piston to reciprocate in accordance with a treatment protocol, thereby to treat a body portion of the body of a subject. A power supply, typically disposed within the housing, is adapted to power at least the motor and the controller.

In some embodiments, the reciprocation assembly includes a plate, mounted onto the shaft of the motor and adapted to rotate therewith, and crank having a first linkage at a first end and a second linkage at a second end, the first linkage coupling the crank to the piston and the second linkage coupling the crank to the plate. In some embodiments, the length-changing assembly is adapted to modify the position of the second linkage relative to the shaft of the motor, thereby to modify the stroke length generated by the crank when the plate rotates with the motor.

In some embodiments, the length-changing assembly includes a bar extending radially away from the shaft of the motor, a connector, movable along the bar, the connector being connected to an end of the reciprocation assembly distal from the piston, and a mobilizing mechanism adapted to move the connector relative to the bar, thereby to modify the stroke length.

In some embodiments, the length-changing assembly includes a bar extending along the plate, radially away from the shaft of the motor, a connector, movable along the bar, the connector being connected to the second linkage, and a mobilizing mechanism adapted to move the connector relative to the bar, thereby to modify the stroke length.

In some embodiments, the mobilizing mechanism includes an electronic mobilizing mechanism, functionally associated with the controller, and adapted to receive from the controller input causing the electronic mobilizing mechanism to move the connector relative to the bar. In some embodiments, the electronic mobilizing mechanism includes a piezoelectric motor.

In some embodiments, the length-changing assembly includes a user-interface portion accessible from the exterior of the housing, and the mobilizing mechanism includes a manual mobilizing mechanism, functionally associated with the user-interface portion, such that user manipulation of the user-interface portion causes motion of the connector relative to the bar.

In some embodiments, the bar is threaded and wherein user manipulation of the user-interface portion causes the bar to rotate relative to the connector, thereby causing the connector to move along the bar.

In some embodiments, the percussive massage device further includes a user interface, the user interface adapted to be operated by a user to provide to the controller parameters of the treatment protocol to be used for treatment of a subject.

In some embodiments, the percussive massage device further includes a computer memory having stored thereon at least one pre-set treatment protocol. The user interface is adapted to be operated by the user to select one of the at least one pre-set treatment protocol, thereby to provide to the controller the parameters of the treatment protocol.

In some embodiments, the user interface includes a display adapted to provide to the user information about the treatment protocol or the progress of the treatment.

In some embodiments, the percussive massage device further includes an activation trigger and a safety switch, wherein the controller is adapted to activate the motor only when both the activation trigger and safety switch are depressed.

In some embodiments, the controller is adapted to activate the motor only following confirmation, by the user, of the treatment protocol to be used, and when both the activation trigger and safety switch are depressed.

In some embodiments, the percussive massage device further includes a communication interface adapted for remote communication with a remote computing device.

In some embodiments, the percussive massage device further includes an orientation sensor adapted to provide to the controller input relating to a three-dimensional orientation of the device.

In accordance with an embodiment of the disclosed technology, there is provided a system for treatment of a subject, the system including the percussive massage device described hereinabove and a treatment head coupled to the piston of the percussive massage device.

In accordance with an embodiment of the disclosed technology, there is provided a system of treatment of a subject, the system including the percussive massage device described hereinabove and a computing device, remote from the percussive massage device and in communication therewith via the communication interface of the percussive massage device. The percussive massage device is adapted to transmit to the computing device information relating to the treatment protocol or to the progression of treatment for storage in the computing device, or the computing device is adapted to transmit to the percussive massage device stored information relating to a previously used treatment protocol or a previous treatment, the information used by the user for defining the treatment protocol to be used by the controller.

In accordance with an embodiment of the disclosed technology, there is provided a method for treatment of a subject by a user using a percussive massage device as described hereinabove having a treatment head coupled to the piston. The method includes providing to the controller the treatment protocol to be used for the subject, and operating the length-changing assembly to set the stroke length of the reciprocation assembly. Subsequently, the treatment head is positioned adjacent a desired region of the body of the subject, and the controller is activated to cause the piston to reciprocate in accordance with a treatment protocol.

In some embodiments, the percussive massage device includes an activation trigger and a safety switch, and the activating of the controller includes simultaneously depressing the activation trigger and the safety switch.

In some embodiments, providing the treatment protocol includes selecting the treatment protocol from a plurality of pre-set treatment protocols stored in a computer memory of the percussive massage device.

In some embodiments, providing the treatment protocol includes providing inputs to the controller, via a user interface, the inputs including parameters of the treatment protocol to be used.

In some embodiments, providing the treatment protocol includes causing a remote computing device to transmit the treatment protocol to a communication interface associated with the controller.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a simplified block diagram representation of a system including a percussive massage device according to an embodiment of the teachings herein;

FIGS. 2A and 2B are perspective view illustrations of a percussive massage device according to an embodiment of the teachings herein;

FIGS. 3A, 3B, 3C, 3D, 3E, and 3F are planar front, back, right, left, top, and bottom view illustrations of the percussive massage device of FIG. 2A, respectively;

FIGS. 4A, 4B, and 4C are sectional illustrations of the percussive massage device according to an embodiment of the teachings herein;

FIG. 5 is a flow chart of a method of using the percussive massage device of FIGS. 1 to 4B, according to an embodiment of the disclosed technology.

### DESCRIPTION OF SOME EMBODIMENTS OF THE INVENTION

The invention, in some embodiments, relates to the field of percussive massage devices, and more specifically to a percussive massage device having a variable length reciprocation mechanism and to methods of use thereof.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

In accordance with an embodiment of the disclosed technology, there is provided a percussive massage device, adapted to be coupled to a treatment head. The percussive massage device includes a hand-held housing including a handle and a body. A piston is disposed within the body, and is adapted to be coupled to the treatment head. A motor is disposed within the body, and is adapted to rotate about a shaft. A reciprocation assembly is disposed between the piston and the motor and couples the piston to the motor such that rotation of the motor drives reciprocal motion of the piston. The reciprocal motion of the piston has a stroke length. A length-changing assembly is functionally associated with the reciprocation assembly, and is adapted to modify a position of the reciprocation assembly relative to the shaft of the motor, thereby to modify the stroke length of the piston. A controller is adapted to activate the motor to cause the piston to reciprocate in accordance with a treatment protocol, thereby to treat a body portion of the body of a subject. A power supply, typically disposed within the housing, is adapted to power at least the motor and the controller.

In accordance with an embodiment of the disclosed technology, there is provided a system of treatment of a subject, the system including the percussive massage device described hereinabove and a computing device, remote from the percussive massage device and in communication therewith via the communication interface of the percussive massage device. The percussive massage device is adapted to transmit to the computing device information relating to the treatment protocol or to the progression of treatment for storage in the computing device, or the computing device is adapted to transmit to the percussive massage device stored information relating to a previously used treatment protocol or a previous treatment, the information used by the user for defining the treatment protocol to be used by the controller.

In accordance with an embodiment of the disclosed technology, there is provided a method for treatment of a subject by a user using a percussive massage device as described hereinabove having a treatment head coupled to the piston. The method includes providing to the controller the treatment protocol to be used for the subject, and operating the length-changing assembly to set the stroke length of the reciprocation assembly. Subsequently, the treatment head is positioned adjacent a desired region of the body of the subject, and the controller is activated to cause the piston to reciprocate in accordance with a treatment protocol.

In the context of the description and claims herein, the term “user” relates to a human user, trained to operate the percussive device of the disclosed technology. The user may be, for example, a massage therapist, a physical therapist, or any other medical or para-medical practitioner.

In the context of the description and claims herein, the term “subject” relates to a subject being treated using the percussive massage device of the disclosed technology, and can be a human or an animal, e.g., a mammal.

In the context of the description and claims herein, the terms “knock” and “percussion” may be used interchangeably, and all relate to a force generated by a single percussive motion of a percussion assembly of the device, which is typically implemented as a single linear motion of the piston of the device forwardly.

In the context of the description and claims herein, the term “treatment protocol” relates to a sequence of reciprocal motions, and to parameters defining this sequence of reciprocal motions. For example, the treatment protocol may include a type of head used, a number of motions, a duration between motions, a number of cycles of multiple motions, a number of motions per cycle, a duration between cycles, a force (value or range) to be applied by each reciprocal motion, a total force to be applied, a total treatment time, and/or a total number of reciprocal motions (knocks) for the entire treatment.

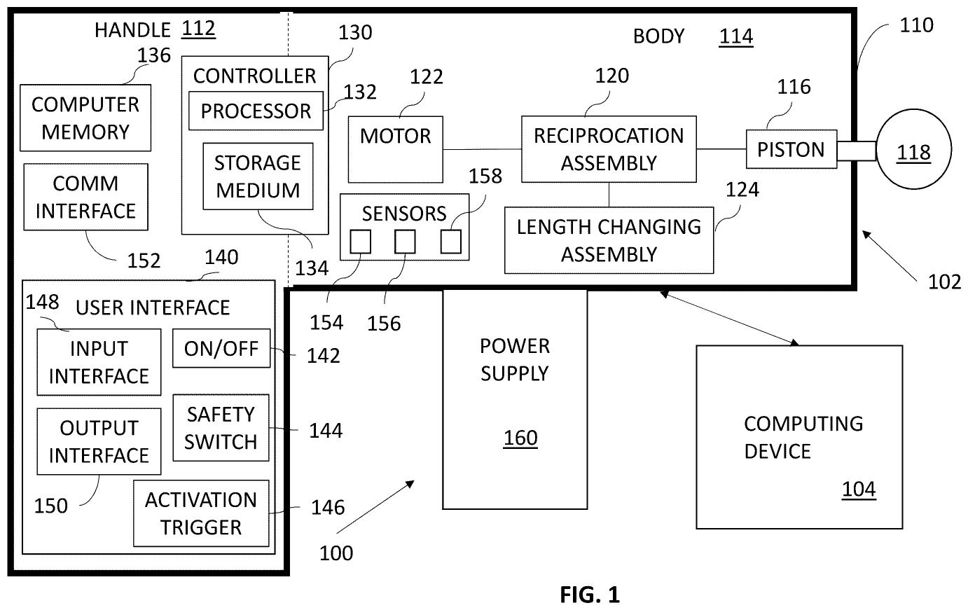

Reference is now made to FIG. 1, which is a simplified block diagram representation of a system including a percussive massage device according to an embodiment of the teachings herein.

As seen in FIG. 1, a system 100 includes a percussive massage device 102 and a remote computing device 104.

Percussive massage device 102 has a housing 110, including a handle 112 and a body 114. Handle 112 may be textured, to ensure easy and secure gripping of device 102 by a user, even if the user's hands have grease or oil thereon from previous application of such substances to a subject.

A piston 116 is disposed within body 114, and is adapted to reversibly couple to a treatment head 118 (i.e. able to couple to the treatment head and to decouple from it). A reciprocation assembly 120 is disposed within housing 110, between piston 116 and a motor 122, such that rotation of the motor drives reciprocal motion of reciprocation assembly 120, resulting in reciprocal motion of piston 116, in a similar manner to that known in the art. Motor 122 is also disposed within housing 110.

It is a particular feature of the disclosed technology that percussive massage device 102 further includes a length-changing assembly 124, adapted to change, or modify, the reciprocation length of reciprocation assembly 120, or the stroke length of device 102, for different treatments, or at different times. Typically, length-changing assembly 124 includes an internal portion disposed within housing 110. The internal portion of length-changing assembly is functionally associated with reciprocation assembly 120, and mechanically changes the reciprocation length of the reciprocation assembly. In some embodiments, length-changing assembly 124 can further include a user-interface portion accessible from outside of housing 110, enabling the user to manually and mechanically control the reciprocation length, as explained in further detail hereinbelow.

Device 102 further includes a controller 130, adapted to control operation of motor 122. In some embodiments, in which length-changing assembly 124 is an electronic assembly, controller 130 may further control its operation. The controller typically includes a processor 132, which may be functionally associated with a non-transitory computer readable storage medium 134 storing software modules including instructions to be executed by the processor 132.

Storage medium 134 stores instructions which, when executed by processor 132, cause device 102 to execute a desired treatment protocol including a sequence of reciprocal motions suitable for a desired treatment. Storage medium 134 stores instructions which, when executed by processor 132, enable a user to program, or to select a pre-programmed, treatment protocol to be executed by device 102. In some embodiments, storage medium 134 may store pre-defined treatment protocols for operation of reciprocation assembly 120. Storage medium 134 may further store instructions which, when executed by processor 132, control operation of length-changing assembly to change a reciprocation length of reciprocation assembly 120.

In some embodiments, device 102 may further include a computer memory 136, functionally associated with controller 130. In some embodiments, computer memory 136 is suitable for storing digital data, such as data relating to the subject, data relating to treatment protocols used on the subject, and the like. In some embodiments, computer memory 136 may have only temporary storage, such that data stored therein is deleted periodically, for example each time the device is turned off. In other embodiments, computer memory 136 may store the data until it is actively deleted from the computer memory.

Typically, device 102 further includes a user interface 140, functionally associated with controller 130. User interface 140 typically includes an on/off switch 142, a safety switch 144, an activation trigger 146, an input interface 148, and an output interface 150. Typically, output interface 150 includes a display, adapted to provide information to the user about a selected treatment protocol and/or about the progress of treatment. In some embodiments, output interface 150 may further include a speaker. Input interface 148 may include any interface module enabling a user to provide input to controller 130 for controlling operation of device 102, or for programming or selecting a treatment protocol. For example, input interface 148 may be implemented as any one or more of a keyboard, a mouse, one or more buttons, a touch pad, a touch screen, and the like.

In some embodiments, and as explained in further detail hereinbelow, controller 130 is adapted to enable operation of motor 122 and of reciprocation assembly 120 only when switch 142 is turned to the “on” position, and both activation trigger 146 and safety switch 144 are pressed simultaneously. In some embodiments, activation of motor 122 and of reciprocation assembly 120 by controller 130 also requires programming or selection of a desired treatment protocol prior to activation of trigger 146 and safety switch 144,

In some embodiments, device 102 may further include a communication interface 152, functionally associated with controller 130 and enabling one-way or two-way communication with a networked environment, for example via a Local Area Network (LAN), a Wide Area Network (WAN), the Internet, or via a Bluetooth® connection. The communication may be wired communication or wireless communication, and may use any suitable protocol known in the art. In some embodiments, controller 130 operates communication interface 152 to transmit data about the subject and/or about a specific treatment protocol used for the subject, to remote computing device 104, for storage therein. For example, remote computing device 104 may be a computer located in a medical practitioner's office or a database associated with a medical insurance provider, adapted to track the treatment history of the subject, as well as a medical history and profile of the subject (e.g., subject age, weight, height, medical history, etc). That tracked treatment history can be received from communication interface 152 of device 102. In some embodiments, the tracked treatment history may include one or more of a time-stamp of initiating a treatment session, a timestamp of completing a treatment session, a treatment protocol used during the treatment session (e.g., a number of reciprocal motions or knocks, a sequence of reciprocal motions, measured or estimated force applied by each reciprocal knock, measured or estimated force applied during the entire treatment session, treatment regions, number of knocks per each treatment region, frequencies, stroke length, pain measurement possibly obtained from an algometer, and the like).

Remote computing device 104 may be any suitable computing device, including, for example, a desktop computer, a laptop computer, a database, a mobile telephone, a tablet computer, a smart watch, and the like.

In some embodiments, device 102 may further include an orientation sensor 154, such as an accelerometer, adapted to sense the three-dimensional orientation of the device relative to the ground, or to the gravitational force. In some such embodiments, orientation sensor 154 may be functionally associated with controller 130, and controller 130 may cause output interface 150 to provide output relating to readings of orientation sensor 154.

In some embodiments, device 102 may further include an inactivity sensing functionality 156 adapted to identify when the device has been inactive for a predetermined duration, and to provide such information to controller 130 for adapting operation thereof so as to preserve power consumption by device 102 when it is inactive. In some embodiments, the inactivity sensing functionality may be a software module running on controller 130. In other embodiments, the inactivity sensing functionality may operate based on input received from a proximity sensor, a motion sensor, or an audio sensor forming part of device 102.

In some embodiments, device 102 may further include a thermal sensor 158, adapted to provide input to controller 130 when a temperature of, or in, device 102 exceeds a predetermined threshold. Processor 132 of controller 130 may then operate a temperature control module to adjust the operation of device 102 to the elevated temperature level, for example by shutting down the device, or by notifying the user of the elevated temperature (e.g., via output interface 150), thereby to provide for safe and robust device operation.

Device 102 further includes at least one power supply 160, adapted to provide power to electronic components of the device, including motor 122, length-changing assembly 124, controller 130, user interface 140, communication interface 152, orientation sensor 154, inactivity sensing functionality 156, and/or thermal sensor 158. Power supply 160 may be any suitable power supply, such as a battery, a rechargeable battery, or a port for connection to a wall mounted socket or other power source. In some embodiments, device 102 is portable, and is designed to be operable without connection to an external power source, or at a distance greater than 1 meter from an external power source, for extended durations of time, in the range of 2-7 or 2-5 hours of non-stop operation.

In some embodiments, power supply 160 can be a rechargeable battery, disposed exterior to housing 110 and reversibly connectable to a suitable port in housing 110. In such embodiments, the battery can be easily replaced when it is depleted, and can be easily modified to an improved battery type when technology enables such improvements.

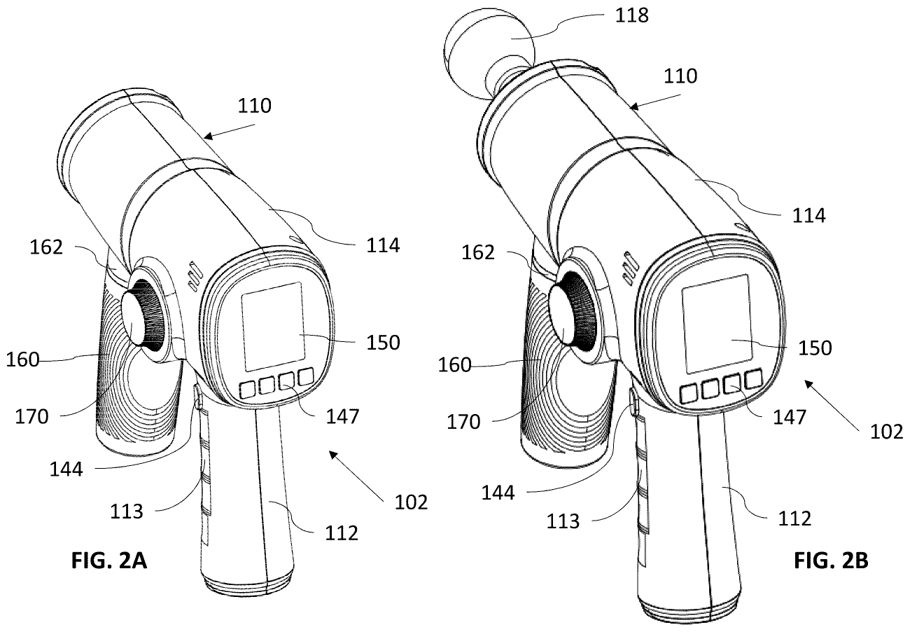

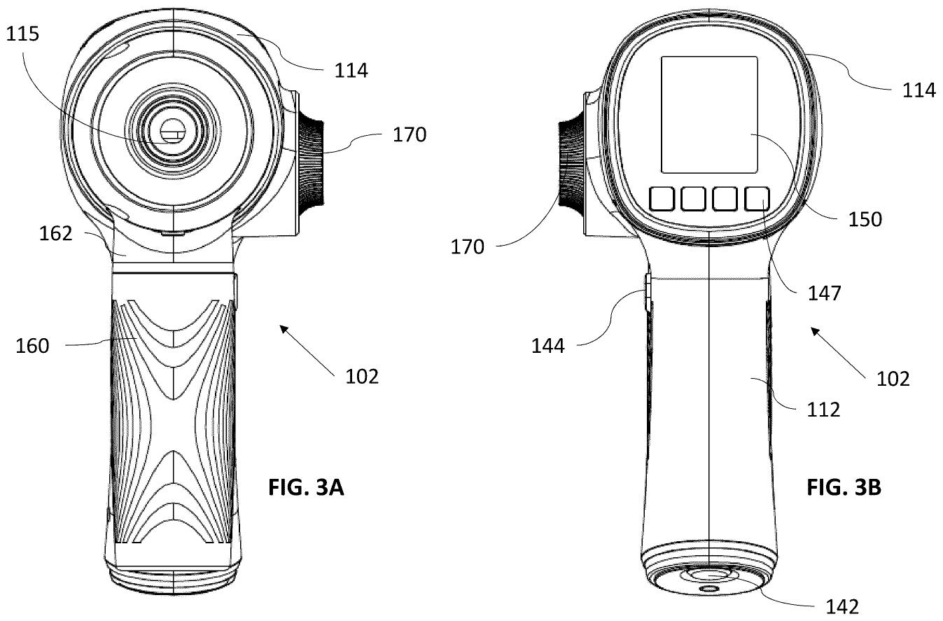

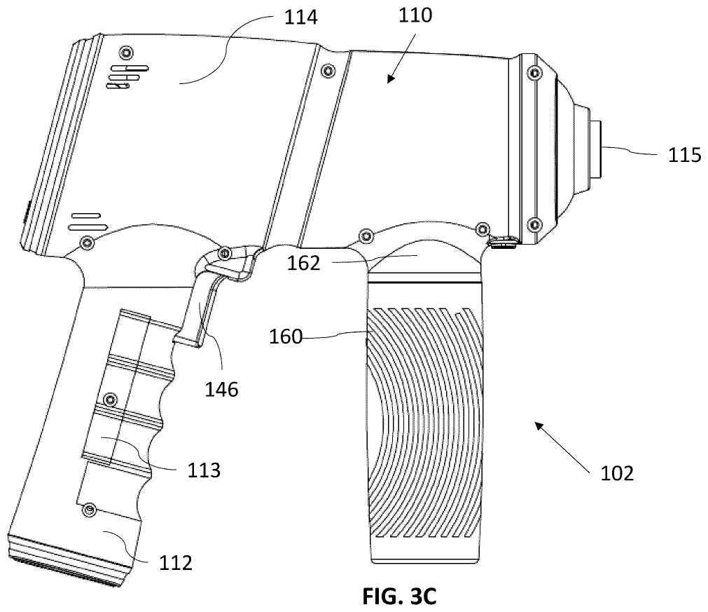

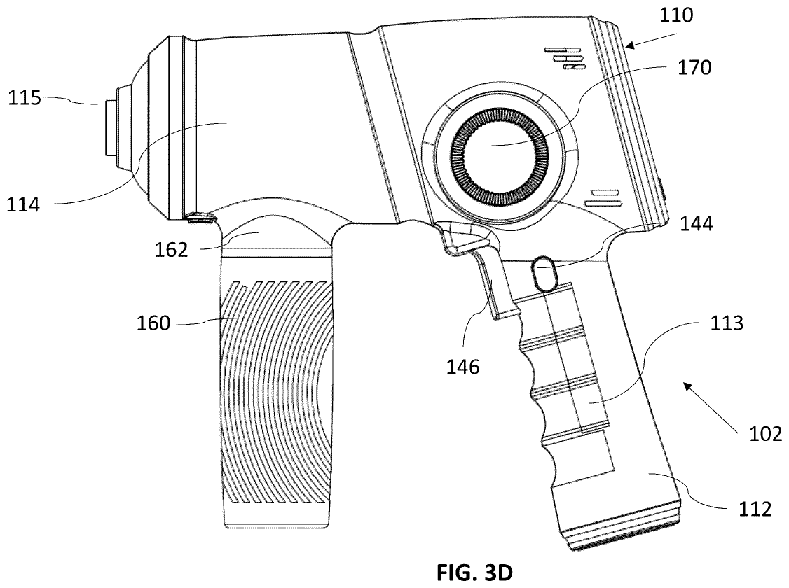

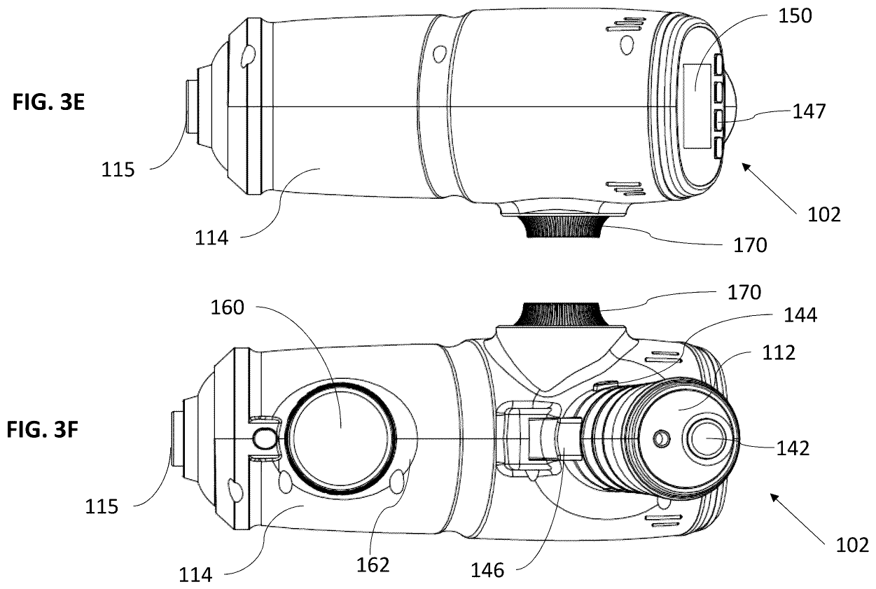

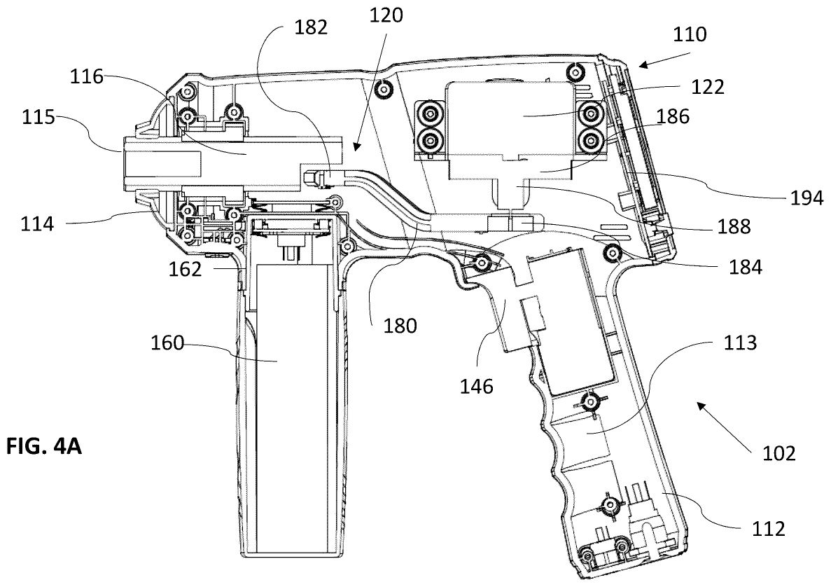

Reference is now made to FIGS. 2A and 2B, which are perspective view illustrations of an exemplary percussive massage device 102 according to an embodiment of the teachings herein, and to FIGS. 3A, 3B, 3C, 3D, 3E, and 3F are planar front, back, right, left, top, and bottom view illustrations of percussive massage device 102 of FIG. 2A, respectively.

As seen in FIGS. 2A to 3F, housing 110 is shaped substantially like the housing of a handgun, and includes a substantially cylindrical body 114 extending forwardly from handle 112. Handle 112 includes a plurality of finger rests 113, and is textured to ensure easy and secure gripping of device 102 by a user, even if the user's hands have grease or oil thereon from previous application of such substances to a subject.

In some embodiments, housing 110 may be reinforced to have sufficient tolerance for application of a force of up to 200 kg force, for repeated use over an extended duration. In some embodiments, housing 110 may include nylon reinforced with fiberglass. In some embodiments, the percentage of fiberglass in the material of housing 110 is at least 10%, at least 12%, or at least 15%.

Battery 160 is removably connected to a suitable port 162 at a bottom of cylindrical body 114. In some embodiments, battery 160 may be distanced from handle 112, such that when the user grips the handle with one hand, they can stabilize their grip by holding battery 160 with the other hand, in a similar manner to that used for precision weapons. In some embodiments, the distance between a rear-facing end of battery 160 and forward-facing end of handle 112 is in the range of 10 mm-20 mm, 10 mm-18 mm, 1 2mm-18 mm, 12 mm-16 mm, or 14 mm-16 mm.

A front end of cylindrical body 114 includes a portal 115, into which a connection end of treatment head 118 (FIG. 2B) can be inserted for coupling with the reciprocating piston (116 in FIG. 1), while the working end of the treatment head remains exterior to the cylindrical body, as explained in further detail hereinbelow. For example, the piston may be coupled to any one of the treatment heads described in PCT Patent Application Publication No. WO2021/053525, or to any other treatment head known in the art and/or commercially available.

As shown clearly in FIG. 3B, a display, functioning as output interface 150, is disposed on a back surface of cylindrical body 114. Additionally, in some embodiments, a plurality of buttons 147, functioning as the input interface, are disposed on the back surface of cylindrical body 114, for example beneath the display. Buttons 147 may include arrow buttons for scrolling through displayed menus, a mode selection button, a frequency selection button, a time selection button, and the like.

In some embodiments, display 150 is adapted to provide information relating to any one of a treatment protocol, a cumulative treatment time, a treatment initiation time, a cumulative force applied (thus far) during the treatment, a cumulative number of knocks applied (thus far) during the treatment, an estimated or measured force applied by each knock during the treatment, a stroke length of the device, an angular orientation of the device (e.g., relative to gravitational pull), an expected time limit for the treatment, an expected number of knocks to be applied, and the like.

An on/off switch 142 is disposed on a bottom surface of handle 112, as seen clearly in FIG. 3F.

Activation trigger 146 is disposed on a forward-facing aspect of handle 112, and safety switch 144 is disposed on a left-side aspect of handle 112, as seen clearly in FIG. 3D. In use, a user would press both safety switch 144 and activation trigger 146, thereby causing the device to operate, as explained in further detail hereinbelow.

It is to be appreciated that, in some embodiments, activation trigger 146 may function differently in different conditions. For example, in some embodiments, a short press of the activation trigger causes the device to apply a single batch, or sequence, of knocks, as defined in the treatment protocol, and stops once the batch is completed. In some such embodiments, a longer press of the activation trigger causes the device to apply multiple such batches of knocks, as defined in the treatment protocol, waiting a predefined duration between each batch or sequence of knocks, as defined in the treatment protocol.

In some embodiments, and as illustrated, a knob 170 is disposed on the side of cylindrical body 114, and functions as a user-interface portion of length-changing assembly 124 (FIG. 1). As explained in further detail hereinbelow, rotation by the user of knob 170 changes the reciprocation length of reciprocation assembly 120, or the stroke length of the device 102, thereby changing the amount of force applied by each stroke of the device.

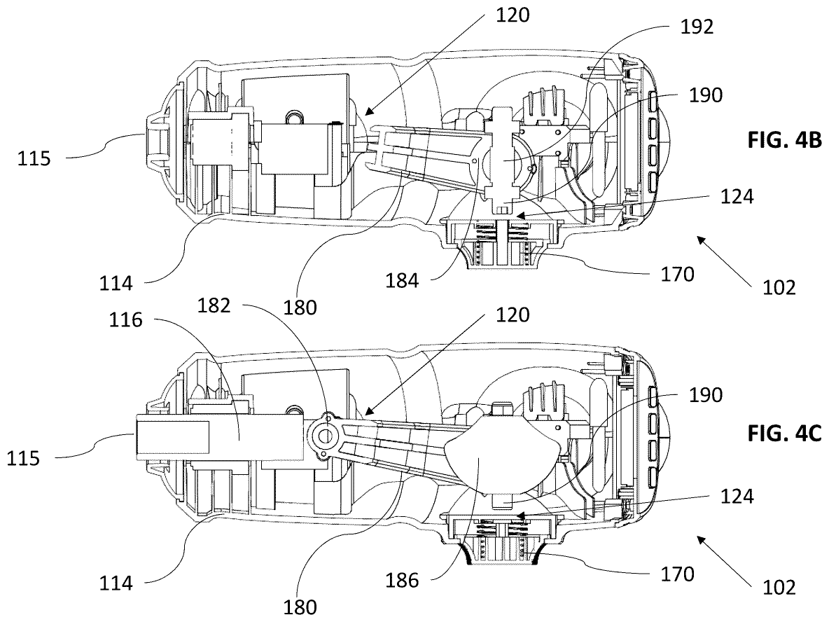

Reference is now made to FIGS. 4A, 4B, and 4C, which are sectional illustrations of the percussive massage device according to an embodiment of the teachings herein.

As seen in FIG. 4A, reciprocation assembly 120 includes a crank 180 having a first linkage 182 connecting the crank to piston 116, and a second linkage 184 coupling the crank to a plate 186 at a connection point on the plate. Plate 186 may be semi-circular, and is functionally associated with, and adapted to be rotated about, a shaft 188 of motor 122. When plate 186 rotates, second linkage 184 rotates with the plate, causing the crank to move piston 116 toward, and away from, portal 115, depending on the distance of the connection point on plate 186 from portal 115. Such motion of piston 116 causes corresponding motion of the treatment head coupled to the piston, resulting in the knocking function of the treatment head.

In some embodiments, and as illustrated, crank 180 may have a bent, or step-shaped, configuration. This configuration facilitates a reduction in the height of cylindrical body 114, resulting in a more compact device 102, which is easier for the user to handle.

As seen in Figured 4B and 4C, knob 170 is coupled to a bar 190 having a connector 192 slidably disposed thereon, the bar and the connector forming part of length-changing assembly 124. Bar 190 extends across plate 186, such that second linkage 184 is connected to connector 192 which is disposed on bar 190 at the connection point. Rotation of knob 170 by the user, causes connector 192 to move along bar 190, for example along an exterior threading of the bar, thereby moving the location of second linkage 184 relative to the bar. This modifies the distance of the connection point of second linkage 184 from shaft 188 of motor 122.

The modification of the distance between second linkage 184 and shaft 188 changes the circumference travelled by the second linkage when plate 186 rotates, thereby changing the longitudinal length of motion occurring at first linkage 182 and transmitted to piston 116 to form the knocking action of the piston. Consequently, by rotation of knob 170, the user can change the reciprocation length, or the stroke length, travelled by piston 116 during operation of motor 122.

It is to be appreciated that, in some embodiments, knob 170 may be replaced by a button, such that depression of the button causes the connector 192 to move one step along bar 190. For example, each depression of the button would move the connector one step toward shaft 188, and upon reaching the closest position to the shaft, each depression would move the connector one step farther from the shaft.

In some embodiments, the display may provide to the user an indication of the operative length of crank 180. This would enable the user to evaluate whether the knob/button 170 must be utilized to move the connector 192 to further modify the operative length of the crank, or if all is in order and the treatment can proceed.

In some embodiments, the operative length of crank 180 may vary, by operation of knob 170, within the range of 5 mm to 30 mm. In some embodiments, the operative length of crank 180 may vary, by operation of knob 170, within the range of 5 mm to 25 mm. In some embodiments, the operative length of crank 180 may vary, by operation of knob 170, within the range of 5 mm to 30 mm. In some embodiments, the operative length of crank 180 may vary, by operation of knob 170, within the range of 6 mm to 30 mm. In some embodiments, the operative length of crank 180 may vary, by operation of knob 170, within the range of 6 mm to 25 mm. In some embodiments, the operative length of crank 180 may vary, by operation of knob 170, within the range of 6 mm to 23 mm. In some embodiments, the operative length of crank 180 may vary, by operation of knob 170, within the range of 10 mm to 30 mm. In some embodiments, the operative length of crank 180 may vary, by operation of knob 170, within the range of 12 mm to 30 mm. In some embodiments, the operative length of crank 180 may vary, by operation of knob 170, within the range of 15 mm to 30 mm.

In some embodiments, the force applied by a treatment head coupled to piston 116 in a single reciprocation of reciprocation assembly 120 is in the range of 20 kg force to 170 kg force. In some embodiments, the force applied by a treatment head coupled to piston 116 in a single reciprocation of reciprocation assembly 120 is in the range of 20 kg force to 170 kg force. In some embodiments, the force applied by a treatment head coupled to piston 116 in a single reciprocation of reciprocation assembly 120 is in the range of 40 kg force to 170 kg force. In some embodiments, the force applied by a treatment head coupled to piston 116 in a single reciprocation of reciprocation assembly 120 is in the range of 60 kg force to 170 kg force. In some embodiments, the force applied by a treatment head coupled to piston 116 in a single reciprocation of reciprocation assembly 120 is in the range of 80 kg force to 170 kg force. In some embodiments, the force applied by a treatment head coupled to piston 116 in a single reciprocation of reciprocation assembly 120 is in the range of 100 kg force to 170 kg force. In some embodiments, the force applied by a treatment head coupled to piston 116 in a single reciprocation of reciprocation assembly 120 is in the range of 120 kg force to 170 kg force. In some embodiments, the force applied by a treatment head coupled to piston 116 in a single reciprocation of reciprocation assembly 120 is in the range of 150 kg force to 170 kg force. In some embodiments, the force applied by a treatment head coupled to piston 116 in a single reciprocation of reciprocation assembly 120 is in the range of 20 kg force to 150 kg force. In some embodiments, the force applied by a treatment head coupled to piston 116 in a single reciprocation of reciprocation assembly 120 is in the range of 20 kg force to 120 kg force. In some embodiments, the force applied by a treatment head coupled to piston 116 in a single reciprocation of reciprocation assembly 120 is in the range of 20 kg force to 100 kg force. In some embodiments, the force applied by a treatment head coupled to piston 116 in a single reciprocation of reciprocation assembly 120 is in the range of 20 kg force to 80 kg force.

It is to be appreciated that in some embodiments, knob 170 may be replaced by an electronic component, such as a piezoelectric motor, functionally associated with the controller and with connector 192. In such embodiments, the user may select a suitable stroke length, for example using the user interface, and a suitable command would be provided from the processor to the piezoelectric motor, causing the piezoelectric motor to move connector 192 along bar 190, until the connector and second linkage 184 are at the desired position relative to shaft 188 of the motor.

In some embodiments, the user can set the desired force to be applied by each knock, or the desired stroke length of the device, using input interface 148, and the processor can automatically cause the piezoelectric motor to generate motion of connector 192 along bar 190, to position the second linkage at a suitable location in order to provide the desired force.

In some embodiments, the user can set the desired force to be applied by each knock using input interface 148, and while the user operates knob 170, or an equivalent button, the processor can cause the output interface to provide an indication when the second linkage 184 is at a suitable location in order to provide the desired force.

Returning to FIG. 4A, it is seen that in some embodiments, a circuit board 194 is disposed within cylindrical body 114, for example adjacent the display and the back wall of the body. For example, circuit board 194 may house controller 130, processor 132, storage medium 134, and/or switches associated with user interface 140.

In some embodiments, the treatment head coupled to percussive device 102 may be a large treatment head, for example suitable for application to the chest of a subject for treatment of cystic fibrosis. Examples of such large heads include AP212, AP242, AP229, AP234, and AP235, all of which are adapted to be coupled to a G5 Vibracare percussor massager, all commercially available from Mercury Medical of Clearwater, FL. In some such embodiments, an adapter (not explicitly shown) may be coupled to piston 116, such that the large treatment is coupled to the piston via the adapter.

It is to be appreciated that typical use of large treatment heads, for example in respiratory treatment, involves eccentric motion causing percussion of the large treatment head. By contrast, in the present application, the large treatment head percusses by linear motion of piston 116 along cylindrical body 114, which is distinct from prior art uses.

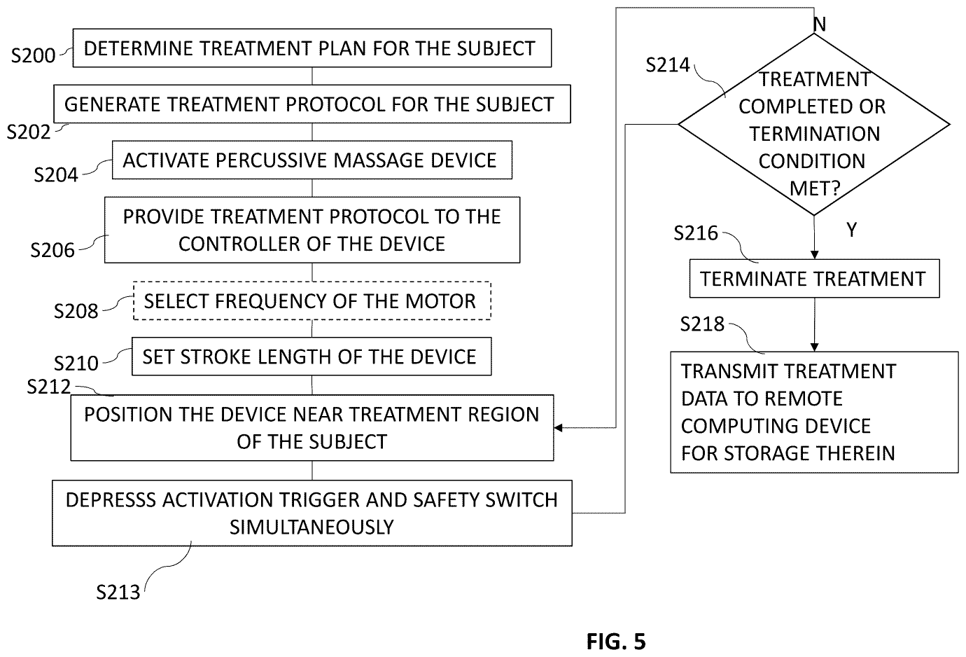

Reference is now made to FIG. 5, which is a flow chart of a method of using the percussive massage device 102 of FIGS. 1 to 4C, according to an embodiment of the disclosed technology.

As seen, at an initial step S200, the user, which is typically a medical or para-medical practitioner, conducts an initial checkup to determine a suitable treatment plan for the subject, and at step S202 the user generates a corresponding treatment protocol for treatment of the subject using device 102.

Typically, the generated treatment protocol includes information relating to at least some of the following parameters:
A treatment head to be used;
A number of knocks to be applied in each sequence of knocks
A repose duration between knocks within a sequence
A number of sequences of knocks
A hiatus duration between sequences of knocks
A desired force to be applied in each knock
A total or maximal force to be applied during the treatment
A total or maximal number of knocks to be applied during the treatment
A total or maximal duration of the treatment
A desired operative length of the crank, or stroke length, for each knock
An angular orientation of the device during application of the knocks
An intensity of each knock, based on the frequency or rpm of the motor during operation
A determination whether all knocks have the same intensity or varying intensities.

In some embodiments, the generated protocol may correspond to a pre-set treatment protocol, for example stored in a memory component of device 102. In other embodiments, the generated protocol may be generated “from scratch” by the user.

In some embodiments, the treatment protocol may include application of a single strong knock at a specific angle, for example to apply significant force to a specific joint, in a similar manner to that used in chiropractic treatments.

In some embodiments, the treatment protocol may include application of a sequence of multiple knocks (e.g., 3, 5, 10 knocks) of a specific force, where each pair of knocks is separated by a repose duration.

In some embodiments, the treatment protocol may include application of a plurality of sequences of knocks, each sequence including a plurality of knocks (e.g., 3, 5, 10 knocks) of a specific force, where each pair of knocks is separated by a repose duration. Each pair of sequences of knocks is separated by a hiatus duration.

In some embodiments, the treatment protocol may require continuous treatment, where the piston carries out periodic reciprocal motion causing periodic knocks to be applied until the treatment duration is met, the maximal or desired number of knocks is met, or the treatment is otherwise terminated.

At step S204, the user activates device 102 by pressing the on/off switch 142, and at step S206 operates user interface 140, and specifically the input interface thereof, to provide the generated protocol to controller 130 of the device. In some embodiments, the providing of the generated protocol comprises providing at least some parameters of the treatment protocol to the device. In some embodiments, the providing of the generated protocol comprises selecting a pre-defined protocol from a list of protocols stored in a memory component of device 102. In some embodiments, providing of the treatment protocol may also include limiting at least one parameter of the treatment, such as the maximal duration of the treatment, the maximal number of knocks to be applied, or the maximal force applied during the treatment.

In some embodiments, a previously stored treatment protocol for the subject can be extracted, for example from remote computing device 104, and transmitted to the device 102 as the treatment protocol, to facilitate treatment continuity. In some embodiments, the current treatment protocol may be a modification of a previously stored treatment protocol, for example modified by the user in accordance with a response of the subject to the stored treatment protocol.

In some embodiments, at an optional step S208, the user may select the frequency of the motor, or the intensity, to be used during the treatment. The selected frequency may be fixed for the entire treatment, or may oscillate, or fade, during the treatment duration.

At step S210, the stroke length of device 102 is set, by activating length-changing assembly 124 to move the second linkage 194 to the desired location relative to shaft 188 of motor 122. In some embodiments, step S210 is carried out manually, for example by the user turning knob 170 or otherwise interacting with a user interface portion of length-changing assembly 124. In some other embodiments, step S210 is carried out automatically, for example by controller 130 operating length-changing assembly 124 to set the stroke length to be suitable for providing a specified force in each knock.

At step S212, the user positions the device 102 near a desired location on the subject's body, and at step S213 depressed activation trigger 146 simultaneously with depressing safety switch 144, thereby causing the controller to activate motor 122 to cause reciprocating motion of piston 116 and of head 118.

It is to be appreciated that depressing of activation trigger 146 activates the device only when accompanied by simultaneous depressing of safety switch 144, and in some embodiments only when preceded by specification of a treatment protocol. Additionally, in some embodiments, it is mechanically difficult or impossible to lock safety switch 144 in the depressed position, thereby preventing accidental activation of the device.

In some embodiments, the depressing of activation trigger is short, and triggers activation of a single sequence of knocks as defined in the treatment protocol. In some embodiments, the depressing of the activation trigger is longer, and triggers activation of multiple sequences of knocks as defined in the treatment protocol. In some embodiments, the depressing of the activation trigger is continuous and triggers continuous reciprocation of the treatment head.

At step S214, controller 130 evaluates whether the treatment has been completed or at least one termination condition has been met. For example, a termination condition may include reaching a maximal treatment duration, a maximal number of knocks, or a maximal applied force. If the treatment has been completed or the termination condition has been met, the controller 130 terminates operation of motor 122, and the treatment is complete at step S216.

In some embodiments, at an optional step S218 which may occur during the treatment or following completion thereof, data regarding the treatment is transmitted, e.g. via the transceiver, to the remote computing device 104 or to another database. For example, the data may include the treatment protocol, time stamps for initiation and termination of the treatment, the reason for terminating the treatment, and information relating to a response of the subject to the treatment (e.g., a pain level experienced during the treatment, an improvement experienced following the treatment, and the like).

As discussed hereinabove, the device and method of the disclosed technology are designed for medical and paramedical treatment of subjects, typically humans or mammals. For example, the device and method may be used in physical therapy, sports therapy, chiropractic therapy, and the like. The device and method may be used to treat muscles, joints, bones, or any other bodily structure or tissue that requires treatment by one or more knocks to heal or to ease pain of the structure or tissue.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A percussive massage device, adapted to be coupled to a treatment head, the percussive massage device comprising:
a hand-held housing including a handle and a body;
a piston, disposed within the body, and adapted to be coupled to the treatment head;
a motor, disposed within the body, the motor adapted to rotate about a shaft;
a reciprocation assembly disposed between the piston and the motor and coupling the piston to the motor such that rotation of the motor drives reciprocal motion of the piston, the reciprocal motion of the piston having a stroke length;
a length-changing assembly, functionally associated with the reciprocation assembly, and adapted to modify a position of the reciprocation assembly relative to the shaft of the motor, thereby to modify the stroke length of the piston;
a controller, adapted to activate the motor to cause the piston to reciprocate in accordance with a treatment protocol, thereby to treat a body portion of the body of a subject; and
a power supply, adapted to power at least the motor and the controller.

2. The percussive massage device of claim 1, wherein the reciprocation assembly comprises:
a plate, mounted onto the shaft of the motor and adapted to rotate therewith; and
crank having a first linkage at a first end and a second linkage at a second end, the first linkage coupling the crank to the piston and the second linkage coupling the crank to the plate,
wherein the length-changing assembly is adapted to modify the position of the second linkage relative to the shaft of the motor, thereby to modify the stroke length generated by the crank when the plate rotates with the motor.

3. The percussive massage device of claim 1, wherein the length-changing assembly comprises:
a bar extending radially away from the shaft of the motor;
a connector, movable along the bar, the connector being connected to an end of the reciprocation assembly distal from the piston; and
a mobilizing mechanism adapted to move the connector relative to the bar, thereby to modify the stroke length.

4. (canceled)

5. The percussive massage device of claim 3, wherein the mobilizing mechanism comprises an electronic mobilizing mechanism, functionally associated with the controller, and adapted to receive from the controller input causing the electronic mobilizing mechanism to move the connector relative to the bar.

6. (canceled)

7. The percussive massage device of claim 3, wherein the length-changing assembly comprises a user-interface portion accessible from the exterior of the housing, and wherein the mobilizing mechanism comprises a manual mobilizing mechanism, functionally associated with the user-interface portion, such that user manipulation of the user-interface portion causes motion of the connector relative to the bar.

8. The percussive massage device of claim 7, wherein the bar is threaded and wherein user manipulation of the user-interface portion causes the bar to rotate relative to the connector, thereby causing the connector to move along the bar.

9. The percussive massage device of claim 1, further comprising a user interface, the user interface adapted to be operated by a user to provide to the controller parameters of the treatment protocol to be used for treatment of a subject.

10. The percussive massage device of claim 9, further comprising a computer memory having stored thereon at least one pre-set treatment protocol, wherein the user interface is adapted to be operated by the user to select one of the at least one pre-set treatment protocol, thereby to provide to the controller the parameters of the treatment protocol.

11. The percussive massage device of claim 9, wherein the user interface comprises a display adapted to provide to the user information about the treatment protocol or the progress of the treatment.

12. The percussive massage device of claim 1, further comprising an activation trigger and a safety switch, wherein the controller is adapted to activate the motor only when both the activation trigger and safety switch are depressed.

13. The percussive massage device of claim 12, wherein the controller is adapted to activate the motor only following confirmation, by the user, of the treatment protocol to be used, and when both the activation trigger and safety switch are depressed.

14. The percussive massage device of claim 1, further comprising a communication interface adapted for remote communication with a remote computing device.

15. The percussive massage device of claim 1, further comprising an orientation sensor adapted to provide to the controller input relating to a three-dimensional orientation of the device.

16. A system for treatment of a subject, the system comprising:
the percussive massage device of claim 1; and
a treatment head coupled to the piston of the percussive massage device.

17. A system of treatment of a subject, the system comprising:
the percussive massage device of claim 14; and
a computing device, remote from the percussive massage device and in communication therewith via the communication interface of the percussive massage device,
wherein the percussive massage device is adapted to transmit to the computing device information relating to the treatment protocol or to the progression of treatment for storage in the computing device, or
wherein the computing device is adapted to transmit to the percussive massage device stored information relating to a previously used treatment protocol or a previous treatment, the information used by the user for defining the treatment protocol to be used by the controller.

18. A method for treatment of a subject by a user using a percussive massage device of claim 1 having a treatment head coupled to the piston, the method comprising:
providing to the controller the treatment protocol to be used for the subject;
operating the length-changing assembly to set the stroke length of the reciprocation assembly;
positioning the treatment head adjacent a desired region of the body of the subject; and
activating the controller to cause the piston to reciprocate in accordance with a treatment protocol.

19. The method of claim 18, wherein the percussive massage device includes an activation trigger and a safety switch, and wherein the activating of the controller comprises simultaneously depressing the activation trigger and the safety switch.

20. The method of claim 18, wherein the providing of the treatment protocol comprises selecting the treatment protocol from a plurality of pre-set treatment protocols stored in a computer memory of the percussive massage device.

21. The method of claim 18, wherein the providing of the treatment protocol comprises providing inputs to the controller, via a user interface, the inputs comprising parameters of the treatment protocol to be used.

22. The method of claim 18, wherein the providing of the treatment protocol comprises causing a remote computing device to transmit the treatment protocol to a communication interface associated with the controller.
